(19) United States
(12) Patent Application Publication
(10) Pub. No.: US 2016/0120147 A1
(43) Pub. Date: May 5, 2016

(54) DEVICE TO STORE, TRANSPORT AND PROVIDE FOOD AND DRINKS TO PETS, CONSISTS OF A CONTAINER WITH A CONCAVE BOTTOM WHICH IS INSERTED IN A BASE WITH A CONVEX CENTRE, A SCREW-ON LID AND A HOLE ON THE SIDE AS A HANDLE

(71) Applicant: ROSALES PERALTA ANTONIO, Santiago (CL)

(72) Inventor: ROSALES PERALTA ANTONIO, Santiago (CL)

(21) Appl. No.: 14/795,525

(22) Filed: Jul. 9, 2015

(30) Foreign Application Priority Data
Oct. 30, 2014 (CL) 201402965

(51) Int. Cl. A01K 7/00; A01K 5/01

(52) U.S. Cl. CPC A01K 7/005; A01K 5/0114

(57) ABSTRACT

The invention is a device that consists of a circular-shaped container with an aluminum seal or similar at the mouth to preserve its contents. It has a plastic screw-in lid that allows to store and transport the container content safely once opened. This fits into a base that keeps the device from moving and allows the consumption of the contents without spills. The base may or may not have a hole on the side for easy transportation.

### FIELD OF THE INVENTION

This utility model consists of a device that stores, transports and supplies food and drink to pets, which consists of two elements: a) disposable container with an aluminum seal or similar with a detachable flap and a threaded lid; and b) base of a diameter than the container and the container fits therein perfectly thus preventing its movement once the contents in the device are used. The base can have a hole on the edge as to assist with the transportation. Usage of either the food or liquid contained inside the container takes place after the lid and seal are removed, and the container can be closed again when packing the threaded lid, thus facilitating transportation of the food or liquid remaining in the container without spillage of any kind.

### BACKGROUND OF THE INVENTION

Currently liquids for dogs or pets available in the market are available in plastic bottles wherein there liquid contained inside the container needs to be transferred into a different container, such as a plate, as to make possible the pet to drink such liquid. The action above described is inconvenient as it is necessary to carry two different containers, i.e., the bottle and the additional container. Also, there is granulated material commercially available which is used to change the flavor, add nutrients to the water the pets drink which therefore makes necessary to have a different container to be used to place the water as to then add the granulated material or nutrients. As conventional containers for pet food are not provided with a plastic threaded lid or cap it is not possible to store and carry the remaining liquid or food without spilling such liquid or food. In addition to that, the plate is not provided with a support base and pets usually turn over such plates with their paws and legs. Also, the plates that are available in the market are not provided with a hole as to make it easier to carry it around. Lastly, the design of the base is such that it takes into account the pet placing the front legs on it, thus preventing movement of the container and allowing the pet to use the contents without producing any spillage.

The device consists of a container which is round in shape and that is provided with an aluminum seal or similar on the mouth as to preserve the contents and provided with a plastic threaded lid or cap which allows to store and carry the container once such container has been opened. The container is attached to a base wherein the pet places its front legs thus preventing movement of the device and allowing the pet to use the contents of the device without having any spillage. The base can be provided or not with a hole on the side of the base as to facilitate carrying the device around.

The solution proposed in the present application is mainly targeted to provide an appropriate container for a pet as to facilitate that the pet can drink the liquid or eat the food without the need of completely emptying any given product onto a plate for further drinking or eating by the pet. Also, it is disposable in nature. Accordingly it is not necessary to wash it after it has been used; it is provided with a seal as to appropriately preserve its vacuum-sealed contents. It is also provided with a threaded lid as to be able to transport the rest of the contents inside the container without nay spillage, and it is also provided with a base that prevents movement of the container and which renders the container flat and stable.

### SUMMARY

The device consists of a circular-shaped container with an aluminum seal or similar at the mouth to preserve its contents and that has a plastic screw-in lid that allows to store and transport the container content safely once opened. This fits into a base, where the pet supports it with its front paws and keeps the device from moving and allows the consumption of the contents without spills.

This base may or may not have a hole on the side for easy transportation.

The solution proposed in this application is mainly based on providing an adequate container for pets so they may consume liquid or food without having to empty such product onto a plate for consumption. In addition to being disposable. In addition to being disposable, meaning that it does not need to be washed after use, it has a seal to properly preserve its content which is vacuum sealed, it also has a screw-on lid in order to transport the rest of the container content without spilling and has a base that immobilizes and stabilizes the container.

### BRIEF DESCRIPTION OF FIGURES

FIG. 1: Illustrates s a plan view of the container.

FIG. 2: Illustrates a front view of the container.

FIG. 3: Illustrates a plan view of the base.

FIG. 4: Illustrates a front view of the base.

FIG. 5: Illustrates a front view of the device before being assembled.

FIG. 6: Illustrates the complete device assembled.

FIGS. 7 and 7a: Illustrate a plan view and a front view respectively showing the slippery material provided underneath the bottom portion of the base.

FIGS. 8 and 8a: Illustrate a plan view and a front view respectively showing the perimeter projection 7.

FIGS. 9 and 9a: Illustrate a plan view and a front view respectively showing the perimeter groove.

FIGS. 10 and 10a: Illustrate a plan view and a front view respectively showing the slippery material provided in the outer lower portion of the container.

FIG. 11: Illustrates a plan view showing the threaded lid 1 provided with anti-slippery section 8.

FIG. 12: Illustrates a side view showing the threaded lid 1 provided with anti-slippery section 8.

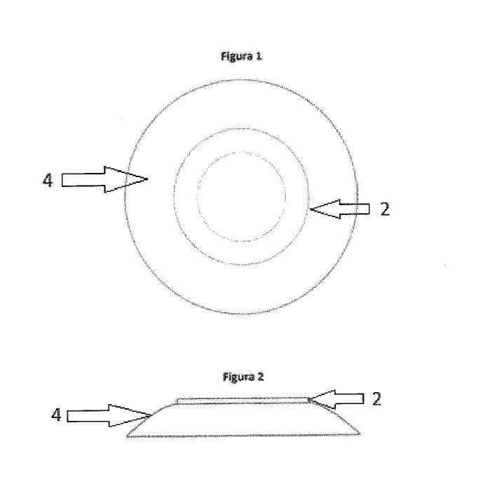

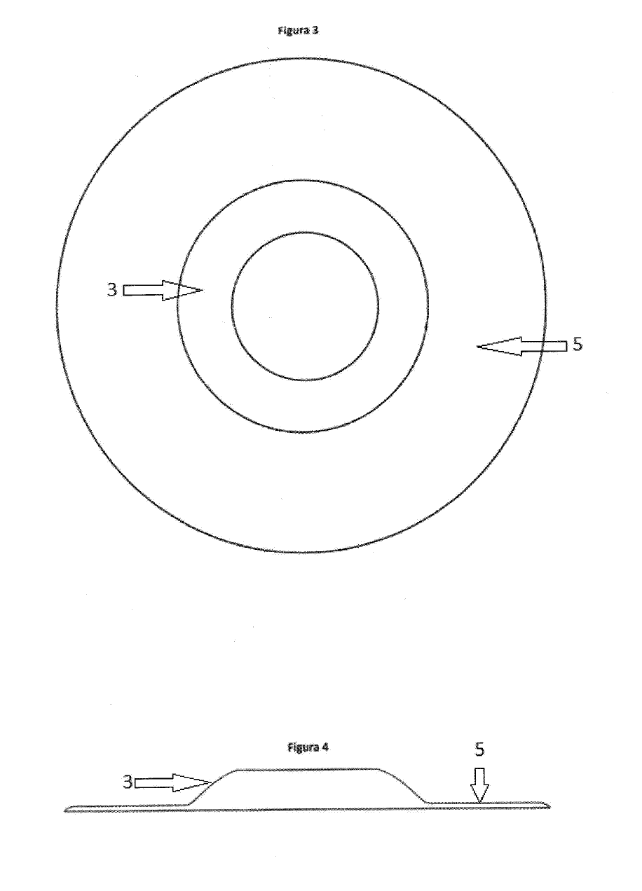

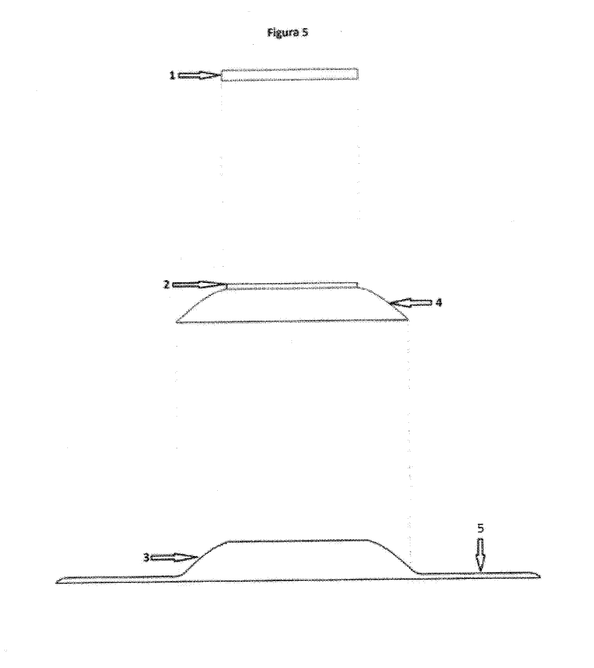

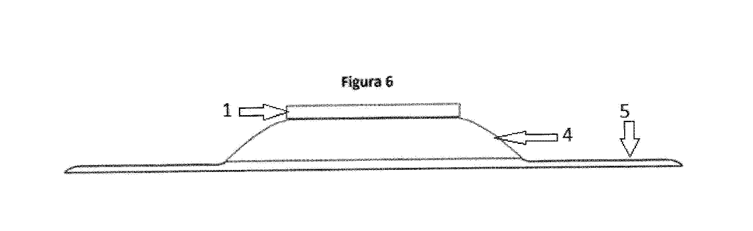

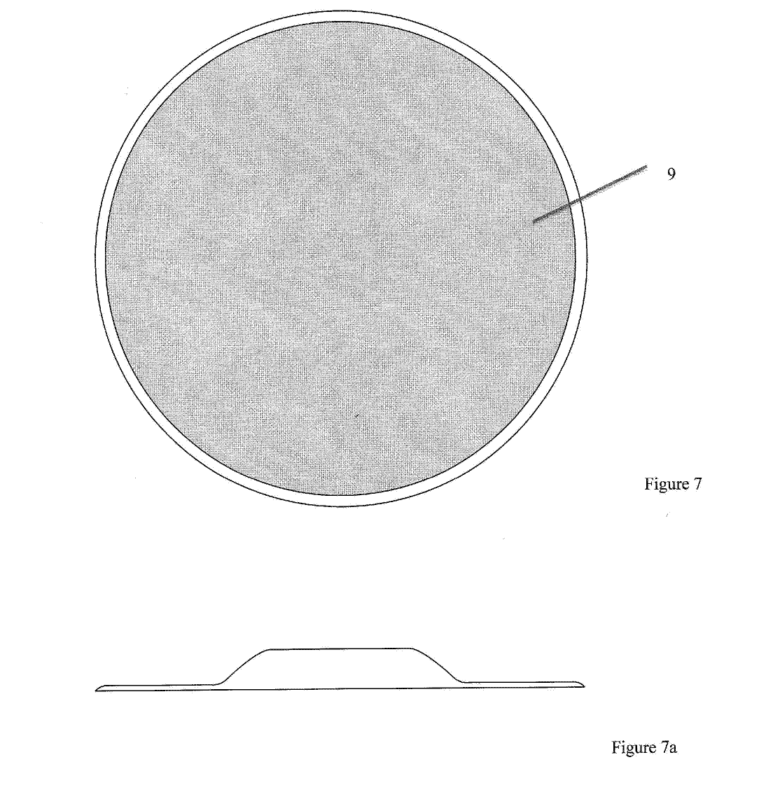

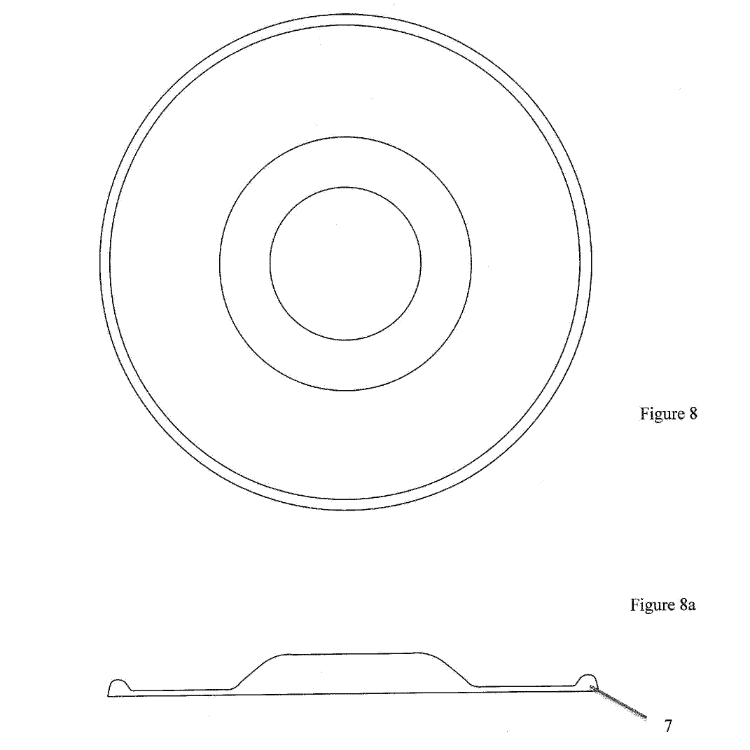

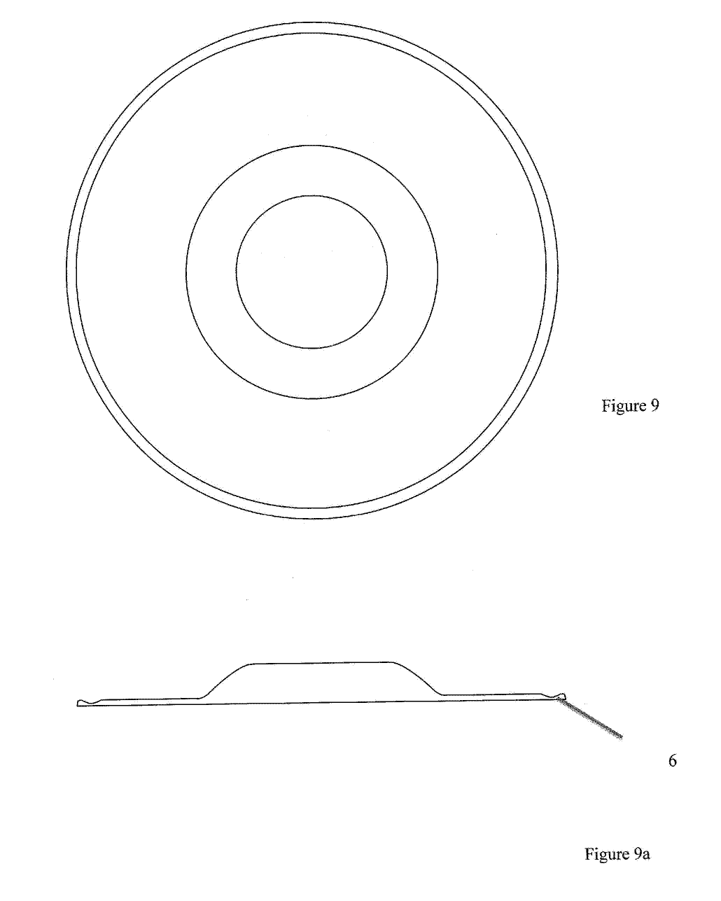

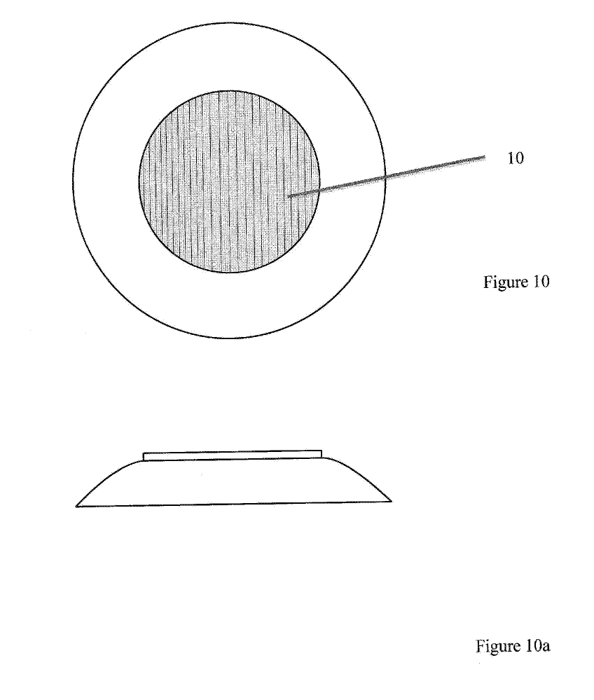

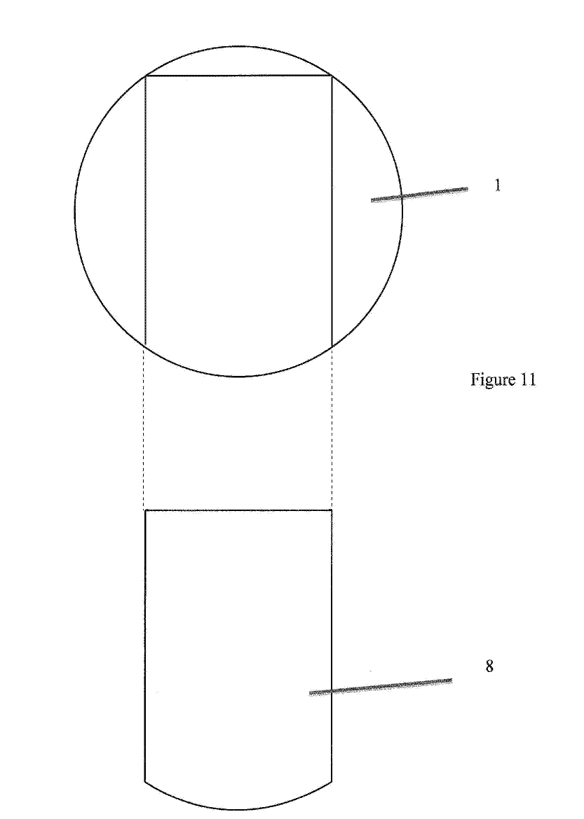

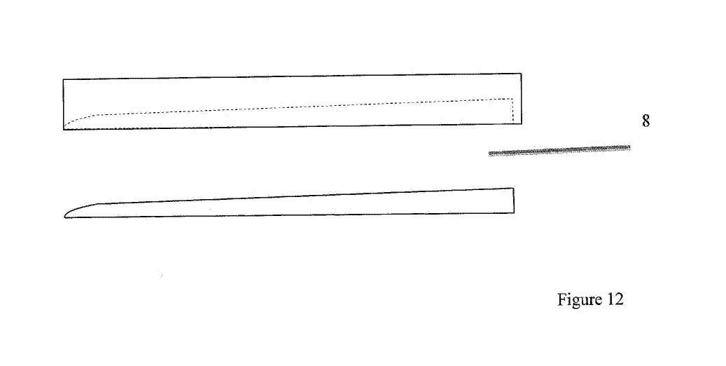

### DETAILED DESCRIPTION OF INVENTION

The device of the invention is provided with a container that has a shallow a shallow bottom which is provided with a plastic threaded lid (1) which is attached to the upper part of the container above the seal (2) which is attached thereof as to preserve its contents inside the container.

The base is provided with a shallow center wherein a central portion (3) is projected and that is of similar shape of the container and through which a perfect fit is provided in-between both the container and the base, thus preventing movement of the base. The container is provided on its side portion with a hole that can be used as a handle or grip 4, and the base is also provided with another hole which can also act as a handle or grip (5) wherein both handles provide a good grip to assist on the container be carried by an individual.

The container can be divided into two parts, one for food and the other for the liquid. Both sections are separated by a plate, thus keeping each other separated.

A preferred embodiment of the device is a base that is provided with a groove 6 that runs along the outer edge and which is intended to be filled with water, thus preventing ants and other insects to have access and climb the base and reach the container.

In other preferred embodiment of the invention the base is provided with a projection or bulge 7 that has the purpose of preventing spillage of food outside of the container.

In yet other preferred embodiment of the invention the threaded lid 1 is provided with a sliding section 8 which creates a flap or spatula which when removed acts as a tool to collect food spilled or feces of the animals feeding from the container.

The lower portion of the base in contact with the floor or surface where the base rests is provided with an anti-slippery material 9 as to prevent the base from moving when the animal is eating.

Also, the base is provided in its outer lower portion with an anti-slippery section 10 preventing the plate from moving or sliding when the plate is not placed inside the base as to feed the animal.

The complete assembly consisting of lid, container, and base is manufactured using different types of material such as polyethylene terephthalate (PET), high density polyethylene, low density polyethylene, polyvinyl chloride, polypropylene, polystyrene, poly(methyl methacrylate), white paper, cardboard, tetra pack, PET, other plastics, glass, aluminum, and other metals. It is also considered using one of the materials within those that are biodegradable as well as a material that are edible for pets and animals without causing any harm.

In a preferred embodiment of the invention the container is made up of any of the materials previously mentioned used in combination in the composition, either used as a coating or as a bath with copper or copper salts, thud providing the container with anti-bacterial properties.

The container can also be manufactured in different layers as to provide the inner walls inside the container with insulating material, thus providing protection against cold and hot room temperature. The container may be for example manufactured using polyethylene for the walls and can be filled with polyurethane in the inside as to provide the container with insulation properties.

1. (canceled)

2. (canceled)

3. A device for storing, transporting, and providing food or liquids to pets WHEREIN the device consists of a container provided with a shallow bottom part where a base is inserted, the base is provided with a convex center; wherein the container is provided with an aluminum seal 2 or similar, with a detachable flap that provides an effective way to preserve the contents of the container; a threaded lid 1 to provide carrying the contents of the container without having any spillage; is provided with a hole in the side part that acts as a handle 4 as to carry the device; wherein the base is provided with a central part 3 which projects from the base and which is convex in shape and which is of a smaller size than the shallow bottom of the container, thus providing the container with a more effective support, and wherein the pet can rest its front paws thus stabilizing and immobilizing the device, and wherein the base is also provided with a hole that acts as a handle 5.

4. A device for storing, transporting, and providing food or liquids to pets according to claim 3 WHEREIN the device can be divided in two sections by means of a separating plate.

5. A device for storing, transporting, and providing food or liquids to pets according to claim 3 WHEREIN said base is provided with a groove 6 that runs around the outer edge.

6. A device for storing, transporting, and providing food or liquids to pets according to claim 3 WHEREIN said threaded lid 1 is provided with a slippery section 8 which creates a flap or spatula.

7. A device for storing, transporting, and providing food or liquids to pets according to claim 3 WHEREIN said base is also provided with an anti-slippery material 9 on the part of the base that is in contact with the floor or surface where the base rests.

8. A device for storing, transporting, and providing food or liquids to pets according to claim 3 WHEREIN the container includes an anti-slippery section 10 in its outer lower portion.

9. A device for storing, transporting, and providing food or liquids to pets according to claim 3 WHEREIN said lid, container, and base are manufactured using different types of material such as polyethylene terephthalate (PET), high density polyethylene, low density polyethylene, polyvinyl chloride, polypropylene, polystyrene, poly(methyl methacrylate), white paper, cardboard, tetra pack, PET, other plastics, glass, aluminum, and other metals.

10. A device for storing, transporting, and providing food or liquids to pets according to claim 3 WHEREIN said lid, container, and base are manufactured using biodegradable materials.

11. A device for storing, transporting, and providing food or liquids to pets according to claim 3 WHEREIN said lid, container, and base are manufactured using material that is safe to eat by the animals.

12. A device for storing, transporting, and providing food or liquids to pets according to claims 9 WHEREIN said container is made up of any of the materials previously mentioned used in combination in the composition, either used as a coating or as a bath with copper or copper salts, thud providing the container with anti-bacterial properties.

13. A device for storing, transporting, and providing food or liquids to pets according to claims 10 WHEREIN said container is made up of any of the materials previously mentioned used in combination in the composition, either used as a coating or as a bath with copper or copper salts, thud providing the container with anti-bacterial properties.

14. A device for storing, transporting, and providing food or liquids to pets according to claims 11 WHEREIN said container is made up of any of the materials previously mentioned used in combination in the composition, either used as a coating or as a bath with copper or copper salts, thud providing the container with anti-bacterial properties.

15. A device for storing, transporting, and providing food or liquids to pets according to claims 9 WHEREIN said container can also be manufactured in different layers as to provide the inner walls inside the container with insulating material.

16. A device for storing, transporting, and providing food or liquids to pets according to claims 10 WHEREIN said container can also be manufactured in different layers as to provide the inner walls inside the container with insulating material.

17. A device for storing, transporting, and providing food or liquids to pets according to claims 11 WHEREIN said container can also be manufactured in different layers as to provide the inner walls inside the container with insulating material.

18. A device for storing, transporting, and providing food or liquids to pets according to claims 12 WHEREIN said container can also be manufactured in different layers as to provide the inner walls inside the container with insulating material.
